(19) United States
(12) Patent Application Publication
(10) Pub. No.: US 2005/0248931 A1
(43) Pub. Date: Nov. 10, 2005

(54) Sensor activated door handle light

(76) Inventor: Heather Alvarez, Glenn, CA (US)

Correspondence Address: Heather Alvarez, 3294 Barnett Ave, McKinleyville, CA, 95519-9347, US

(21) Appl. No.: 10/841,919

(22) Filed: May 10, 2004

(51) Int. Cl. E05B 17/10

(52) U.S. Cl. 362/100; 362/276; 362/394

(57) ABSTRACT

The Sensor Activated Door Handle Light is a visual aid to assist one in locating a door handle in darkness. It is operated independently of household current and makes it ideal as a safety device in the event power to the home is interrupted. It also aids in the location of the door in the event the room is filled with smoke during a fire. Activation of the LED light source can be manually switched or activated audibly via clapping of the hands. The battery-operation of the unit makes ideal for use at all times but makes it especially desirable during emergencies. LED powered light sources have proven to be durable and reliable in impact applications such as a door slamming. Furthermore many young children are not tall enough to reach conventional light switches they can be taught to clap their hands giving enough light for the child to enter a dark room safely.

### CROSS-REFERENCE TO RELATED APPLICATIONS

N/A

### FEDERALLY SPONSERED RESEARCH

N/A

### SEQUENCE LISTING OR PROGRAM

N/A

### FIELD OF INVENTION

This invention relates to the ability of one to find a door and reduce darkness in during power outages, fire, and nighttime.

### BACKGROUND OF THE INVENTION

The Sensor Activated Door Handle Light is a visual aid to assist one in locating a door handle in darkness. It is operated independently of household current and makes it ideal as a safety device in the event power to the home is interrupted. It also aids in the location of the door in the event the room is filled with smoke during a fire. Activation of the LED light source can be manually switched or activated audibly via clapping of the hands. The battery-operation of the unit makes ideal for use at all times but makes it especially desirable during emergencies. LED powered light sources have proven to be durable and reliable in impact applications such as a door slamming. Furthermore many young children are not tall enough to reach conventional light switches they can be taught to clap their hands giving enough light for the child to enter a dark room safely.

Other inventors has attempted to address the need for illuminated door handles but have failed or have disadvantages as follows; U.S. Pat. No. 6,447,139 fails to provide large area light dispersement, ease of installation, complete door handle ring illumination, and relies on incandesant light sources thus requiring regular servicing of light bulbs either from impact failure of the door closing or burn out; U.S. Pat. No. 4,777,570 is difficult to turn on, fails to be easily installed, and relies on incandesant light sources thus requiring regular servicing of light bulbs either from impact failure of the door closing or burn out, U.S. Pat. No. 6,431,012 relies on a daily light source to charge the phosphorus light source and cannot be turned off when one does not require the light source.

### DRAWING DESCRIPTION

FIG. 1 is an isometric view of the Sensor Activated Door Handle Light (Door Brite Nite Light) invention. The purpose of said invention is to provide an easily activated, isolated power source, with a rugged light source for easily locating a door or semi illuminating a room in darkness. The invention is designed to be easily manufactured partially by the plastic injection molding process, but can be manufactured by several methods. Incorporated in the design are a self-contained power source, and audible activator switch, a manual switch, and the LED light source. It also provides for easy installation requiring no tools to place or remove the invention allowing for easy serviceability.

FIG. 2 section view of the side locating the switch and battery compartment.

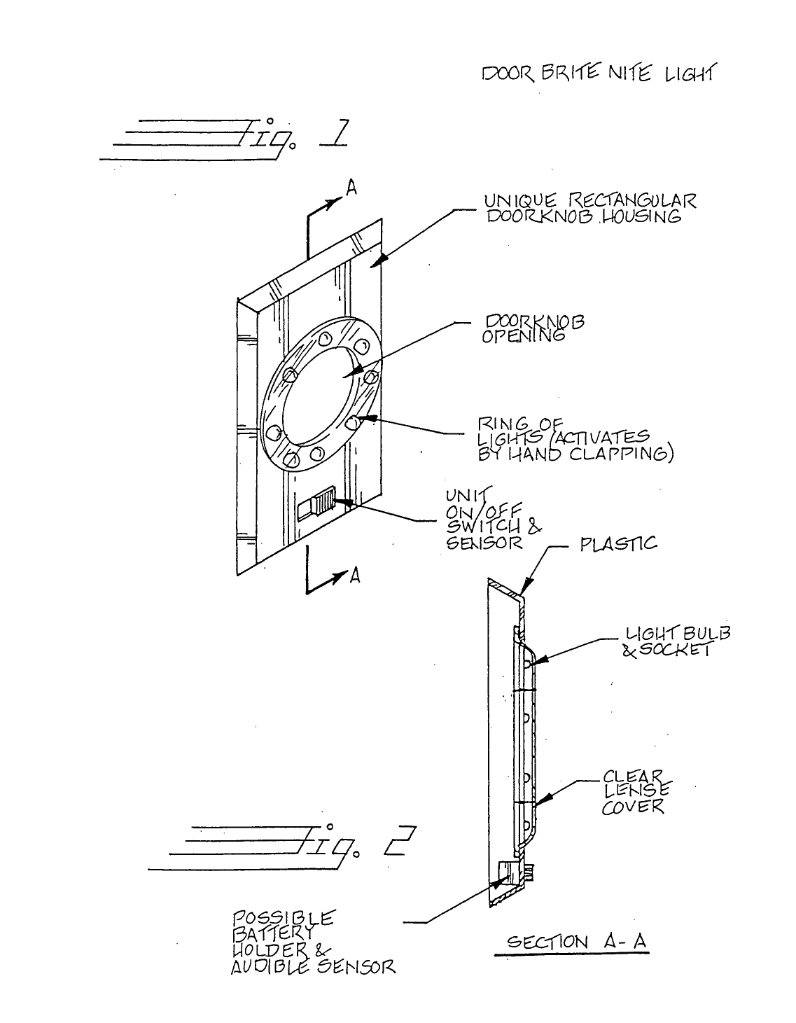

### DETAILED DESCRIPTION OF THE INVENTION

The Sensor Activated Door Handle Light is a visual aid to assist one in locating a door handle in darkness. This provides additional safety during emergencies, finding an entrance or exit in a dark or smoke filled room. It also can provide a light source that is accessible for children or others who would have difficulty in reaching a conventional light switch.

The invention is operated independently of household current and makes it ideal as a safety device in the event power to the home is interrupted. By relying on a battery pack to power the unit instead of phosphorus or hard-wired options it provides a reliable, safe power source.

Activation of the LED light source can be manually switched or activated audibly via clapping of the hands. The battery-operation of the unit makes ideal for use at all times but makes it especially desirable during emergencies. Many young children are not tall enough to reach conventional light switches they can be taught to clap their hands giving enough light for the child to enter a dark room safely.

By using LED powered lights over incandesant options we have reduced the failure and serviceability factor of conventional light bulbs that are prone to failure under impact and usage.

1. A sensor activated door handle light that is easily manufactured and installed, with a ring comprising of plastic and off the shelf electronics and LED's, with a circular opening for the door knob:
a. said unit has a ring of LED's in a circular pattern that surround the door knob,
b. said unit has on off switch for operation that controls the LED's,
c. said unit also has and audible sensor that is adjustable for sensor frequency for controlling operation of LED's,
d. said unit encases all components in a plastic housing and lens cover for LED's to reduces impact damage,
e. said unit houses a self-contained battery source
